(19) United States
(12) Patent Application Publication
(10) Pub. No.: US 2024/0062157 A1
(43) Pub. Date: Feb. 22, 2024

(54) LOGISTICS MANAGEMENT SYSTEM

(71) Applicant: Sungmin Choi, Seoul (KR)

(72) Inventor: Sungmin Choi, Seoul (KR)

(21) Appl. No.: 18/451,326

(22) Filed: Aug. 17, 2023

(30) Foreign Application Priority Data
Aug. 22, 2022 (KR) 10-2022-0104906

(51) Int. Cl. G06Q 10/0875; G06Q 30/0601; G06V 10/20

(52) U.S. Cl. CPC G06Q 10/0875; G06Q 30/0635; G06V 10/255; G06V 2201/10; G06V 2201/07

(57) ABSTRACT

Proposed is a logistics management system. The system includes an ordering application configured to run on a mobile terminal of a person in charge of ordering of a wholesaler, to analyze an image obtained by photographing a retailer's product shelf to identify inventory only for the wholesaler's products, and to create a purchase order for a product that is out of stock, and a management server configured to manage the purchase order uploaded from the ordering application.

### CROSS REFERENCE TO RELATED APPLICATION

The present application claims priority to Korean Patent Application No. 10-2022-0104906, filed Aug. 22, 2022, the entire contents of which is incorporated herein for all purposes by this reference.

### BACKGROUND OF THE INVENTION

### Field of the Invention

The present disclosure relates to a logistics management system and, more particularly, to product ordering and consequent product release and receiving.

### DESCRIPTION OF THE RELATED ART

Korean Patent Application Publication No. 10-2021-0079965 discloses inventory management using a smart shelf, performed by a system. According to the system, the smart shelf utilizes an image sensor and a weight sensor installed in display shelves to recognize the arrival and departure of goods, and transmits the acquired information to a server, and the server updates inventory information of a store (retailer) with the information received from the smart shelf. As a result, a store manager is able to place an order for products at an appropriate time on the basis of an automatically managed inventory status. However, in order to manage such inventory status, there is a prerequisite that a smart shelf must be provided in the store.

While most large supermarkets and franchise stores supported by a head office have systems for inventory management and ordering, small and medium-sized wholesalers that deliver a small number of products to their customers (retailers) do not have such a system. Moreover, such a system is not suitable for the small and medium-sized wholesalers, and in many cases, the wholesalers have to visit their customers and manage their own product inventory.

### DOCUMENTS OF RELATED ART

(Patent Document 0001) Korean Patent Application Publication No. 10-2021-0079965

### SUMMARY OF THE INVENTION

Accordingly, the present disclosure has been made keeping in mind the above problems occurring in the related art, and the present disclosure is intended to provide a system that supports small and medium-sized wholesalers to process orders by identifying the inventory status of their customers for the wholesalers' products.

In addition, the present disclosure is intended to provide a system for product release inspection in connection with ordering.

In order to achieve the above objective, according to an aspect of the present disclosure, there is provided a logistics management system, including: an ordering application configured to run on a mobile terminal of a person in charge of ordering of a wholesaler, to analyze an image obtained by photographing a retailer's product shelf to identify inventory only for the wholesaler's products, and to create a purchase order for a product that is out of stock, and a management server configured to manage the purchase order uploaded from the ordering application.

The logistics management system may further include: an outgoing inspection system configured to inspect a product release according to the purchase order uploaded to the management server. The outgoing inspection system may include: a plurality of cameras for outgoing inspection that photographs an outgoing inspection area in an outgoing inspection site of the wholesaler; a weight detection sensor for outgoing inspection that detects a weight of an outgoing product placed in the outgoing inspection area; and an outgoing inspection control unit that recognizes a product by analyzing photographed images obtained from the plurality of cameras for outgoing inspection, and determines that it is normal release when the recognized product matches the product according to the purchase order and the weight detected by the weight detection sensor for outgoing inspection matches a weight calculated based on product quantity according to the purchase order.

According to the present disclosure, due to an ordering system suitable for small and medium-sized wholesalers, the person in charge of ordering of a small and medium-sized wholesaler can easily identify the customer's inventory status of the wholesaler's products delivered to the customer and process an order when the wholesaler visits the customer.

Furthermore, according to the present disclosure, due to an outgoing inspection system linked to the ordering system, product delivery according to a purchase order can be checked to ensure promptness and accuracy of delivery.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a block diagram of a logistics management system according to an embodiment of the present disclosure;

FIG. 2 is a flowchart of inventory identification and order processing of an ordering app according to an embodiment of the present disclosure;

FIG. 3 is an exemplary view of shelves in which products are displayed;

FIG. 4 is a view illustrating the result of identifying the wholesaler's products by analyzing the image of shelves;

FIG. 5 is a block diagram of an outgoing inspection system according to an embodiment of the present disclosure;

FIG. 6 is a view illustrating an outgoing inspection site; and

FIG. 7 is a block diagram of an incoming inspection system according to an embodiment of the present disclosure.

### DETAILED DESCRIPTION OF THE INVENTION

The foregoing and further aspects of the present disclosure will become more apparent through preferred embodiments described with reference to the accompanying drawings. Hereinafter, the present disclosure will be described in detail so that those skilled in the art can easily understand and reproduce the present disclosure through these embodiments.

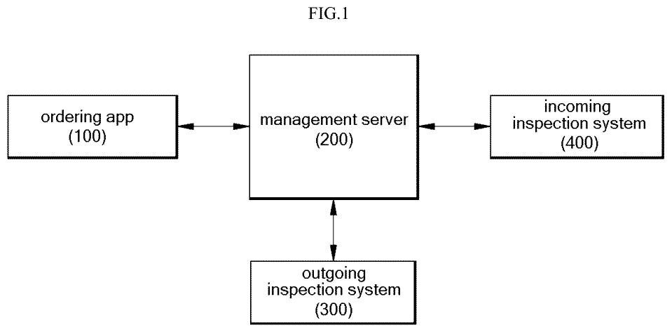

FIG. 1 is a block diagram of a logistics management system according to an embodiment of the present disclosure. The logistics management system includes an ordering application (app) 100 and a management server 200, and may further include an outgoing inspection system 300 and an incoming inspection system 400. The ordering app 100 is installed and executed on a mobile terminal such as a smartphone owned by the person in charge of ordering, and the person in charge of ordering may belong to a wholesaler. The ordering app 100 enables the person in charge of ordering to identify the inventory of the wholesaler's products (its own products) delivered to a customer (retailer) and to process the order at the customer's site. The management server 200 that works with the ordering app 100 stores and manages a purchase order uploaded from the ordering app 100, and may also manage a release receipt of shipped products according to the purchase order. The outgoing inspection system 300 is a system for inspecting the shipping of products for delivery from the wholesaler to the corresponding customer according to the purchase order uploaded to the management server 200, and the incoming inspection system 400 is a system for inspecting receiving of products delivered to the customer according to the purchase order uploaded to the management server 200.

The ordering app 100 will be described in detail. First, the person in charge of ordering visits a customer to manage the inventory of the wholesaler's products delivered to the customer, and executes the ordering app 100 for inventory identification and ordering. The ordering app 100 takes a picture of the product shelf provided in the customer's site according to the operation of the person in charge of ordering, analyzes the image obtained through photographing to identify inventory only for the wholesaler's products, generates a purchase order for the wholesaler's products that are out of stock, and uploads the generated purchase order to the management server 200, so that the wholesaler's products are supplied from the wholesaler to the corresponding customer.

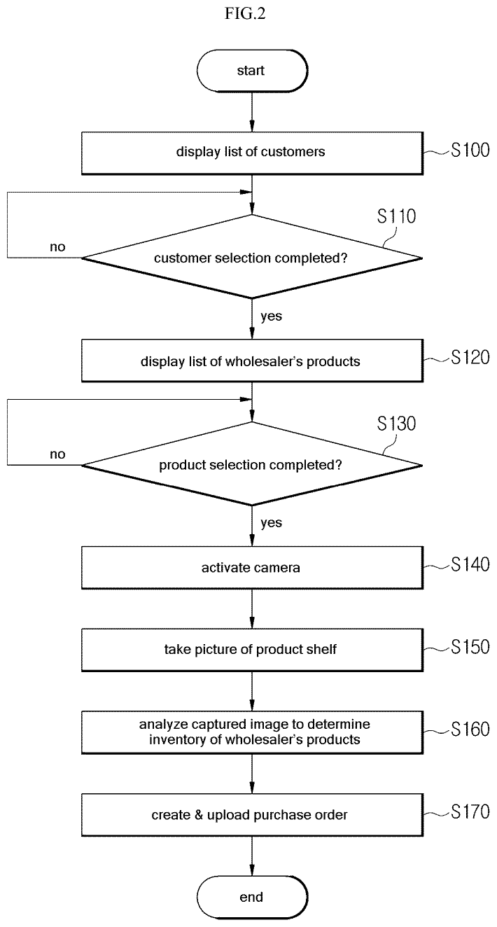

FIG. 2 is a flowchart of inventory identification and order processing of an ordering app according to an embodiment of the present disclosure.

The ordering app 100 displays a user interface including a list of all customers doing business with the wholesaler on a screen so that the person in charge of ordering selects a customer he or she currently visiting from the list of customers (S100). When the customer selection is completed by the person in charge of ordering, the ordering app 100 displays a user interface including a list of the wholesaler's products on the screen so that the person in charge of ordering selects all of the wholesaler's products delivered to the corresponding customer from the list of the wholesaler's products (S110) (S120). When the product selection is completed by the person in charge of ordering, the ordering app 100 activates a camera of the mobile terminal, and takes a picture of the customer's product shelf according to the shooting operation of the person in charge of ordering (S130) (S140) (S150).

The ordering app 100 analyzes the captured image to determine the inventory of the wholesaler's products among the products displayed on the shelf (S160), and creates a purchase order for the wholesaler's products that are out of stock and uploads the purchase order to the management server 200 (S170). According to an embodiment, the ordering app 100 displays the stock status identified for each product of the wholesaler on the screen so that the person in charge of ordering can check the stock status, and generates and uploads a purchase order after receiving an order item and quantity input from the person in charge of ordering. According to another embodiment, the ordering app 100 automatically creates and uploads a purchase order according to a predetermined condition when the inventory quantity identified for each product of the wholesaler is less than the standard quantity.

Step S160 will be further explained. The ordering app 100 may identify the area where the wholesaler's products are displayed in the captured image, and determine the number of the wholesaler's products displayed only for the identified area. As an example, the ordering app 100 checks the same product image by comparing the product images belonging to the captured image with the already registered wholesaler product image, and identifies the area of the product image confirmed to be identical as the area where the wholesaler's product is displayed. In confirming the same product image as the wholesaler's product image, a process of identifying whether the product is the wholesaler's product by checking the product name through text extraction written on the product may be performed.

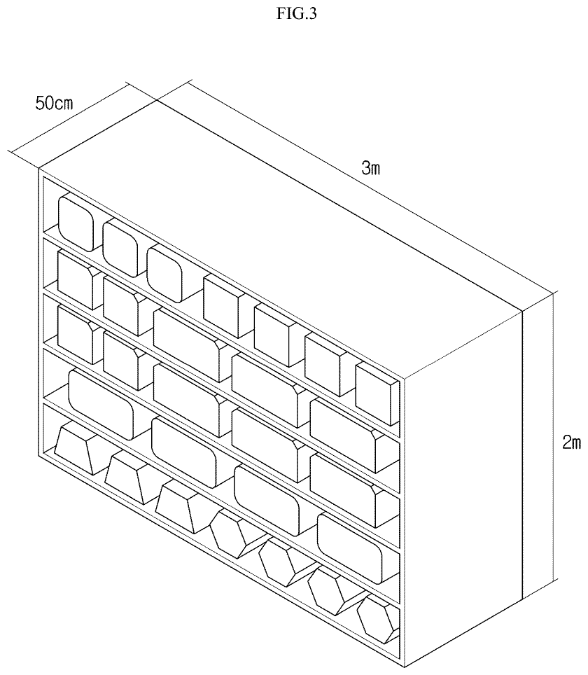

In the embodiment, in analyzing the captured image to determine the stock of the wholesaler's products in step S160, the ordering app 100 identifies the inventory on the basis of size information of the product shelf and size information of the wholesaler's products. The size information of the product shelf and the size information of the wholesaler's products may be registered in advance in the management server 200 and provided to the ordering app 100, and the size information refers to information about width, length, and height. In the case of the product shelf illustrated in FIG. 3, the size information is 3 m wide×50 cm×2 m high. When the size information of a product says 10 cm wide×10 cm long×20 cm high, up to 5 items may be displayed per column, and when the size information of a product says 5 cm wide×5 cm long×20 cm high, up to 10 items may be displayed per column.

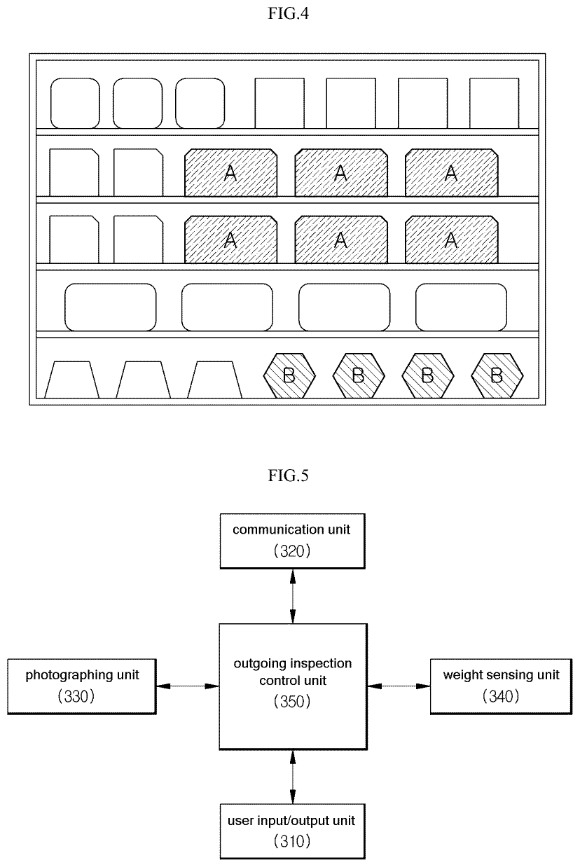

In addition, when the same product is displayed in the column direction as shown in FIG. 2, the ordering app 100 may instruct the person in charge of ordering between steps S130 and S140 to take a picture after pushing back the wholesaler's product displayed on the shelf. Accordingly, the person in charge of ordering may input that the corresponding instruction has been completed after pushing only the wholesaler's product to the back among the products displayed on the shelf, and the ordering app 100 activates the camera and photographs the shelf according to the instruction completion input of the person in charge of ordering. As another example, after activating the camera, the ordering app 100 may identify the wholesaler's product in a preview image, and instruct to take a picture the identified wholesaler's product after pushing the product back. As shown in FIG. 4, the ordering app 100 identifies the wholesaler's product A and the wholesaler's product B and displays the products A and B to be distinguished from other products on the shelf, so that the person in charge of ordering pushes back only the wholesaler's products and then takes a picture.

Thereafter, the ordering app 100 analyzes the captured image to determine the inventory of a wholesaler's product. To be specific, the ordering app 100 may calculate the distance between the front end of the shelf and the wholesaler's product, and determine the inventory of the wholesaler's product on the basis of the shelf size information and the wholesaler's product size information. Alternatively, the ordering app 100 may calculate the actual size of the vacant space that appears when the wholesaler's product is pushed back, and determine the inventory of the wholesaler's product on the basis of the shelf size information and the wholesaler's product size information. In the former case, it is desirable to obtain an image by taking a picture of the product shelf from the front, whereas in the latter case, it is desirable to obtain an image in an oblique direction from top to bottom of the product shelf.

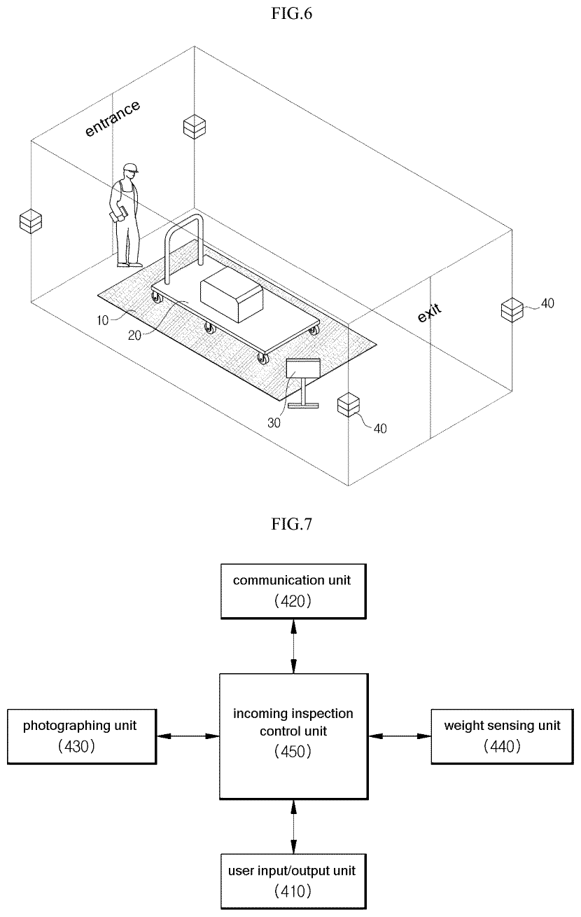

FIG. 5 is a block diagram of an outgoing inspection system according to an embodiment of the present disclosure. The outgoing inspection system 300 includes at least some of a user input/output unit 310, a communication unit 320, a photographing unit 330, a weight detection unit 340, and an outgoing inspection control unit 350. FIG. 6 is a view illustrating an outgoing inspection site. The user input/output unit 310 includes a configuration for user input and a configuration for output to the user, and the input configuration and output configuration are not particularly limited. As an example, the user input/output unit 310 includes a touch screen that simultaneously supports user input and output. The communication unit 320 is for communication with the outside. The outgoing inspection system 300 receives a purchase order uploaded to the management server 200 and inspects whether products are released normally according to the purchase order.

The photographing unit 330 includes a plurality of cameras for photographing an outgoing inspection area 10 in the outgoing inspection site. For reference, although cameras are not shown in FIG. 5, a plurality of cameras are fixed at appropriate points to take pictures of the outgoing inspection area 10 from different directions. This is to photograph the outgoing products placed in the outgoing inspection area 10 from various angles and to accurately identify what the products are by image analysis. The weight detection unit 340 is a sensor provided in the outgoing inspection area 10 to detect a load.

The outgoing inspection control unit 350 is a controller that controls the overall outgoing system. The outgoing inspection control unit 350 compares and analyzes a plurality of captured images taken by the photographing unit 330 to recognize what kind of the wholesaler's products the outgoing products are. To this end, information on the images taken from various angles for each product may be registered in a memory (not shown) in advance, and the outgoing inspection control unit 350 may recognize an outgoing product on the basis of the image information of the wholesaler's products registered in the memory.

When the recognized outgoing product matches an ordered product according to the purchase order, and the weight detected by the weight detection unit 340 matches the total weight of the ordered product according to the purchase order within a predetermined error range, the outgoing inspection control unit 350 determines that it is a normal product release. To this end, the management server 200 may pre-calculate the weight according to the product and quantity of the purchase order and provide the result to the outgoing inspection system 300 together with the purchase order, and may add weight information to the purchase order and provide the purchase order with added weight information to the outgoing inspection system 300. In addition, when it is determined that the product release is normal, the outgoing inspection control unit 350 controls the opening of the exit of the outgoing inspection site so that the product release may be made. The reason for checking even the weight is to ensure accurate shipment according to the order quantity, and to inhibit the release of products that have not been recognized by the camera.

As shown in FIG. 6, the person in charge of shipping puts outgoing products on a cart 20 and enters the outgoing inspection site through the entrance, then puts the cart on the outgoing inspection area 10 so that inspection takes place, and goes out through the open exit when the inspection is completed as normal release. In this process, the outgoing inspection control unit 350 subtracts the pre-registered weight of the cart from the weight detected by the weight detection unit 340 and then compares the resultant value with the total weight of the ordered product. Meanwhile, reference numeral 30 in FIG. 6 denotes an inspection monitor, and when an inspection error occurs, the person in charge of shipping may check the details of the error through the inspection monitor. At least some of the user input/output unit 310, the communication unit 320, and the outgoing inspection control unit 350 may be integrally configured in the inspection monitor. In addition, reference numeral 40 is an alarm, which generates different alarms when it is determined that the release is normal and when it is determined that the release is abnormal.

Furthermore, when it is determined that the release is normal, the outgoing inspection control unit 350 may create a release receipt for the released products and upload the release receipt to the management server 200. Accordingly, the management server 200 receives the uploaded release receipt, stores and manages the uploaded release receipt, and may provide the release receipt to the incoming inspection system 400. At this time, the management server 200 may pre-calculate the weight according to the product and quantity of the release receipt and provide the result to the incoming inspection system 400 together with the release receipt, and may add weight information to the release receipt and provide the release receipt with added weight information to the incoming inspection system 400.

FIG. 7 is a block diagram of an incoming inspection system according to an embodiment of the present disclosure. The incoming inspection system 400 is for inspecting products that are delivered to retailers according to the release receipt uploaded to the management server 200 after being inspected as normal release by the outgoing inspection system 300, and includes at least some of a user input/output unit 410, a communication unit 420, a photographing unit 430, a weight detection unit 440, and an incoming inspection control unit 450. These configurations are substantially identical to those shown in FIG. 5. That is, the outgoing inspection system 300 and the incoming inspection system 400 differ only in that the outgoing inspection system 300 is built in an outgoing inspection site of a wholesaler to inspect the release of products, whereas the incoming inspection system 400 is built in an incoming inspection site of a retailer to inspect the receiving of products delivered from the wholesaler, but the inspection process is actually the same. In addition, the incoming inspection site has actually the same configuration as the outgoing inspection site. Thus, redundant description is omitted.

Meanwhile, the incoming inspection system 400 receives the release receipt through the communication unit 420, and may receive the release receipt directly from the management server 200 or from a separate mobile application. For the latter case, for example, the management server 200 provides the release receipt to a receiving application (not shown) running on a mobile terminal of the person in charge of receiving so that the person in charge of receiving may check the release receipt, and the incoming inspection system 400 may receive the release receipt from the receiving application.

As described above, the present disclosure has been described with reference to the preferred embodiments. Those skilled in the art to which the present disclosure pertains will be able to understand that the present disclosure can be implemented in a modified form without departing from the essential characteristics of the present disclosure. Therefore, the disclosed embodiments should be considered in terms of illustrative rather than limiting of the present disclosure. The scope of the present disclosure is shown in the claims, not the foregoing description, and all differences within the equivalent range should be construed as being included in the present disclosure.

What is claimed is:

1. A logistics management system comprising:
an ordering application configured to run on a mobile terminal of a person in charge of ordering of a wholesaler, to analyze an image obtained by photographing a retailer's product shelf to identify inventory only for the wholesaler's products, and to create a purchase order for a product that is out of stock; and
a management server configured to manage the purchase order uploaded from the ordering application.

2. The logistics management system of claim 1, wherein the ordering application identifies a retailer the person in charge of ordering currently visits from among retailers that the wholesaler transacts with and items traded with the retailer, analyzes the photographed image to identify inventory only for the wholesaler's products corresponding to the identified traded items, and create a purchase order for a product that is out of stock according to the identified inventory status.

3. The logistics management system of claim 2, wherein the ordering application identifies the inventory on the basis of size information of the product shelf and size information of the wholesaler's products.

4. The logistics management system of claim 2, wherein the ordering application displays a user interface for selecting the retailer visited by the person in charge of ordering from among the retailers that the wholesaler transacts with, displays a user interface for specifying a wholesaler's product that is traded with the selected retailer when the retailer is selected by the person in charge of ordering, activates a camera so that the person in charge of ordering takes pictures of the product shelf when the product is specified by the person in charge of ordering, analyzes the photographed image, and identifies inventory only for the specified product.

5. The logistics management system of claim 4, wherein the ordering application outputs a message instructing the person in charge of ordering to push back the wholesaler's product displayed on the product shelf and take a picture.

6. The logistics management system of claim 1, further comprising:
an outgoing inspection system configured to inspect a product release according to the purchase order uploaded to the management server,
wherein the outgoing inspection system comprises:
a plurality of cameras for outgoing inspection that photographs an outgoing inspection area in an outgoing inspection site of the wholesaler;
a weight detection sensor for outgoing inspection that detects a weight of an outgoing product placed in the outgoing inspection area; and
an outgoing inspection control unit that recognizes a product by analyzing photographed images obtained from the plurality of cameras for outgoing inspection, and determines that it is normal release when the recognized product matches the product according to the purchase order and the weight detected by the weight detection sensor for outgoing inspection matches a weight calculated based on product quantity according to the purchase order.

7. The logistics management system of claim 6, when it is determined as the normal release, the outgoing inspection control unit opens and controls an exit of the outgoing inspection site.

8. The logistics management system of claim 6, further comprising:
an incoming inspection system configured to inspect products received by the retailer according to a release receipt uploaded from the outgoing inspection system,
wherein the incoming inspection system comprises:
a plurality of cameras for incoming inspection that photographs an incoming inspection area in an incoming inspection site of the retailer;
a weight detection sensor for incoming inspection that detects a weight of an incoming product placed in the incoming inspection area; and
an incoming inspection control unit that recognizes a product by analyzing photographed images obtained from the plurality of cameras for incoming inspection, and determines that it is normal receiving when the recognized product matches the product according to the release receipt and the weight detected by the weight detection sensor for incoming inspection matches a weight calculated based on product quantity according to the release receipt.

9. The logistics management system of claim 3, wherein the ordering application displays a user interface for selecting the retailer visited by the person in charge of ordering from among the retailers that the wholesaler transacts with, displays a user interface for specifying a wholesaler's product that is traded with the selected retailer when the retailer is selected by the person in charge of ordering, activates a camera so that the person in charge of ordering takes pictures of the product shelf when the product is specified by the person in charge of ordering, analyzes the photographed image, and identifies inventory only for the specified product.

10. The logistics management system of claim 9, wherein the ordering application outputs a message instructing the person in charge of ordering to push back the wholesaler's product displayed on the product shelf and take a picture.
